(19) United States
(12) Patent Application Publication
(10) Pub. No.: US 2010/0229045 A1
(43) Pub. Date: Sep. 9, 2010

(54) Computer Method and Apparatus Providing Invocation of Device-Specific Application Through a Generic HTTP Link

(75) Inventors: Eric Vaughn Schultz, Newton, MA (US); Nicholas Mathias Werthessen, Millis, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Quantia Communications, Inc., Newton, MA (US)

(21) Appl. No.: 12/719,997

(22) Filed: Mar. 9, 2010

Related U.S. Application Data
(60) Provisional application No. 61/158,619, filed on Mar. 9, 2009.

(51) Int. Cl. G06F 15/16; G06F 9/445; G06F 11/30

(52) U.S. Cl. 714/37; 709/217; 717/176; 715/205; 714/E11.179

(57) ABSTRACT

A computer method and system processes and handles hypertext-type links by converting client device-independent URLs to respective device-dependent URLs. This enables invocation of device-specific applications through a generic HTTP link. The HTTP link may be embedded in an email, SMS, web-page or similar communication documents or files.

### RELATED APPLICATION(S)

This application claims the benefit of U.S. Provisional Application No. 61/158,619, filed on Mar. 9, 2009.

The entire teachings of the above application(s) are incorporated herein by reference.

### BACKGROUND OF THE INVENTION

Standard computers and several classes of mobile devices allow applications to be downloaded and to run locally on the device. These applications can leverage local processing, and features and functionality of the device to create more complete, rich and responsive interfaces than is often available using web browsers. Further, these applications are often designed to function locally even when a data connection is not available.

Hypertext technology enables the practice of directing users to specific web pages by sending them links (HTTP URLs) within messages (e.g. email, SMS), or by including such links within web pages themselves. When a user clicks on the HTTP URL most devices will launch a browser to fetch and render the contents of that URL (e.g. a web page).

### SUMMARY OF THE INVENTION

Assignee's applications involve rich media and transactions and are available over the web through a browser on standard computers, and as installed applications on supported mobile devices. Assignee installs their applications on mobile devices for many reason, including but not limited to, immediate access, ability to function without a wireless connection, more responsive user experience, preservation of transactions, user responses, and user activity tracking with an unreliable wireless connection.

When a request is made for a URL over TCP/IP (using http, https, socket connection, etc.), the present invention enables the subject device, regardless of platform, to have the URL request directed to a designated local application allowing the application to interpret and perform appropriate actions indicated by the URL (e.g. present the specified content). Or, if the application is not installed, the invention system presents the user with the ability to download and install the application.

This innovation allows applicants (programmers or other services) to use standard mechanisms of messaging to a user (e.g. email, SMS) or web pages, to notify and direct users to specific content or actions within assignee's native or similar applications across multiple device classes. This provides a standard “push” mechanism to increase overall traffic as well as targeted use of assignee's service, and ability to effectively promote specific content or actions to specific users or groups of users.

This is also useful in adding new users—converting users who may have gotten a link to assignee's content either from an email, SMS, or by browsing a website—who can now conveniently download and install the appropriate version of the local application for their native platform.

The invention methods, systems, apparatuses, and computer-readable mediums with program codes embodied thereon relate to hypertext-type link handling. A method according to an embodiment of the present inventions includes receiving a request made on a Uniform Resource Locator (URL), determining a class of device making the request, and per class of the device, responding with content including redirection instructions to a device-specific URL enabling invocation of a certain application, wherein the device specific URL is specific to the device making the request.

Further, if the certain application is not installed on the device, the method may respond with redirection instructions to a device-specific URL enabling installation of the certain application.

The step of determining the class of device making the request may include inspecting the received request for a platform signature and based on the platform signature determining the class of the device. In addition, a step of the invention method may determine whether the certain application required to render the content is installed on the device. In determining whether the certain application is installed on the device, the received request may be inspected for an encoded registration of the application. Alternatively, determining whether the certain application is installed may include attempting to launch the application and monitoring for a failure of launch of the application.

Furthermore, the method may include enabling the device to register the certain application to render a particular protocol. In addition, the device may be enabled to register an HTTP handler used to launch the certain application.

In another embodiment, computer apparatus processes and handles hypertext-type links. The computer apparatus is formed of a receiver and a server (or processor) elements. The receiver receives from a device, one or more requests made on (or for) a subject URL. In particular, the URL requests that the receiver receives are formed as device-independent URL-requests. The server/processor element is responsive to the received URL-requests and determines a class of the requesting device. Based on the determined class, the server/processor element generates or otherwise provides a device-specific URL. The device-specific URL enables the requesting device to invoke a certain application for rendering the content referenced by the subject URL.

The receiver may be a browser or browser application. Alternatively, the receiver may be a server-side process.

According to another embodiment, the present invention provides a method of launching an application. The method includes using a communication stream or medium to a subject device (e.g., mobile phone, handheld processing device, or other client) indicating a device generic hypertext-type link to a certain application. In addition, the method converts the device generic hypertext-type link to a hypertext-type link that is specific to the subject device, resulting in a subject device-specific hypertext-type link. Further, the method uses the subject device-specific hypertext type link to enable launching (i.e., local launching) of the certain application on the subject device.

It should be understood that the foregoing example embodiments, or aspects thereof, may be combined in systems, devices, methods, etc. to form various combinations of same.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1-3 are flow diagrams of methods of hypertext-type link handling of the present invention implemented on a device using different operating system platforms.

FIG. 4 is a schematic diagram of a computer network environment in which embodiments of the present invention are deployed.

FIG. 5 is a block diagram of a computer node in the network of FIG. 4.

### DETAILED DESCRIPTION OF THE INVENTION

A description of example embodiments of the invention follows. When a request is made on a URL (e.g. the user clicks on a link to an HTTP URL within an email, SMS, webpage, etc), most devices will launch a browser to fetch and render the contents of that URL. Different classes of devices provide varying sets of techniques for constructing a URL that will either be rendered by a registered application or whose content will be provided by a registered handler. The present invention converts the device-independent URL to a device-dependent URL (or URL specific to the device) and provides appropriate behavior even when the third-party software has not been installed.

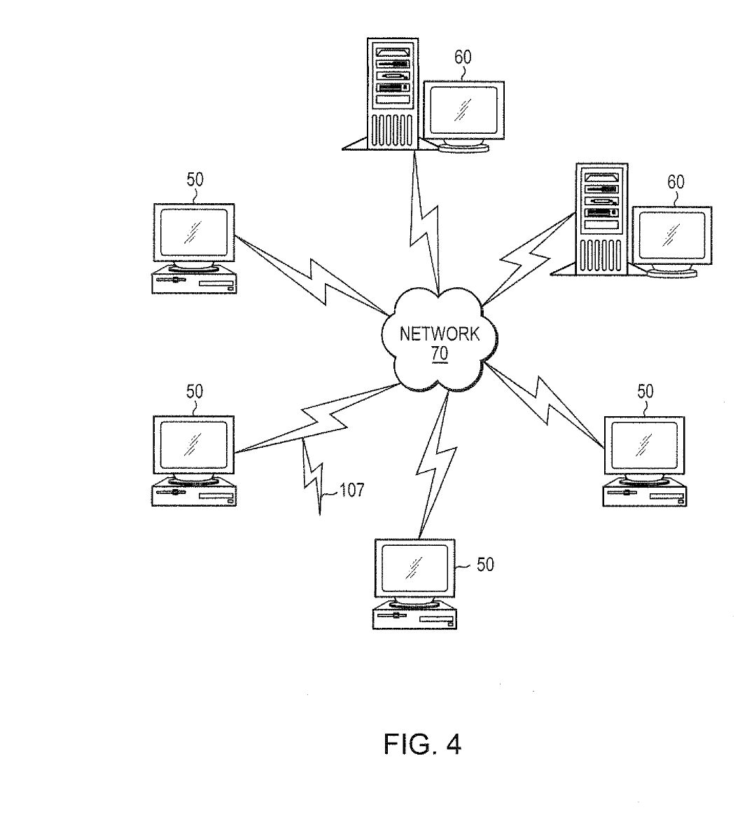

In embodiments of the present invention, when the registered HTTP handler makes its HTTP request to server 60 (FIG. 4 detailed later), the server 60 inspects the request, determines the class of the device 50 making the request, and responds with content that is appropriate for that class of device 50. For some devices 50, like desktops, the server 60 returns content required to render an HTML page. For devices 50 for which a subject application is available, the server 60 includes in the content an HTML page with links to download the application, as well as, redirection instructions to a device-specific URL which causes the application to be invoked locally.

On an individual device 50 where the subject application has already been installed, the application is invoked to interpret the URL and perform the appropriate actions (e.g. render designated content). The structure of the URL and the mechanism of that invocation are specific to the class of the device 50. Some devices 50 allow registration of an application that will be invoked to render a particular protocol (protocol://content-specifier). Other devices 50 allow registration of handlers that are invoked to filter the contents of URLs (either by protocol or by server 60 domain or an HTTP URL). In this latter case, the handler code is used to launch the subject application in addition to supplying some standard HTML response to the browser.

On an individual device 50 where the application has not yet been installed, the HTML page with a link to obtain the application (as returned by server 60) is shown/displayed in the browser.

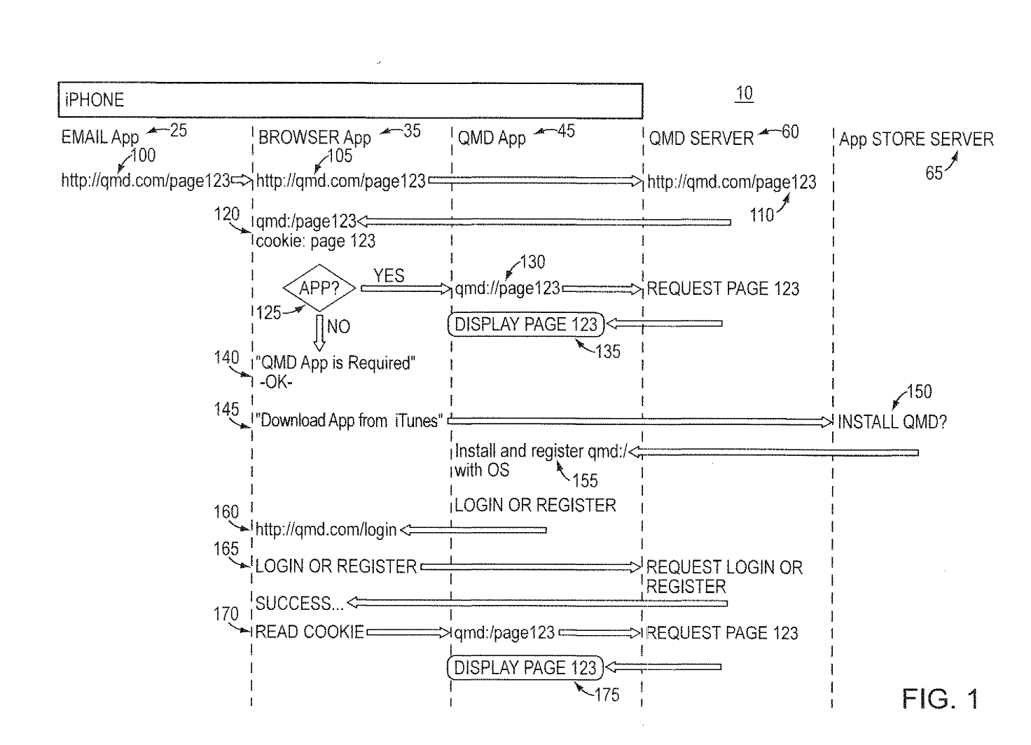

FIG. 1 is a flow diagram of a processor or method 10 embodying the present invention. In particular method 10 provides hypertext-type link handling implemented on a mobile device 50 using an iPhone® operating system platform. The invention method 10 begins at step 100, where a user of an iPhone® device 50 receives an HTTP link (e.g., “http://qmd.com/page123”), which is a device-independent URL, via email using an iPhone® email application 25 and activates the link. It should be noted that the user may receive the HTTP link via SMS or other alternative communication means known to those skilled in the art. The activation of the HTTP link may occur, for example, by the user selecting (clicking) the link, highlighting the link, or copy and pasting the link into a web browser 35 installed on the mobile device 50. Upon activation of the link, at step 105, the browser application 35 sends an HTTP request to server 60. The HTTP request may include device profile information such as information related to the operating platform of the device 50 and any other operating information useful to the server 60. In addition, the request may include a cookie that contains the device 50 profile information.

At step 110, the server 60 inspects the request, determines the class of device 50, and responds with a device-dependent URL. The server 60 may determine the class of the device 50 by inspecting the HTTP request. For example, the server 60 may inspect a cookie that contains the device 50 profile information sent with the request, however, if the request does not contain a cookie the server 60 may inspect the request for a browser signature identifying the platform that the device 50 is operating on (i.e., class of device). Upon determining the class of the device 50, at step 110, the server 60, at step 120 responds to the request with a device-dependent URL that is used by the device 50 to retrieve the content of the subject URL.

At step 125, method 10 determines whether the appropriate application 45 needed to retrieve the content from the URL is installed on the device 50. For example, this determination occurs by method/process 10 attempting to access the content of the URL. In the case that the device 50 has the appropriate application 45, at step 130, the application is automatically launched, and the application 45 requests the content from the server 60. In turn, server 60 responds with the requested content which is subsequently displayed 135 to the user through application 45.

Alternatively, in the case where the application 45 is not installed, the device's attempt to launch the appropriate application fails because the application 45 is not installed. In this instance, at step 140, the device 50 alerts the user with an error message, for example, “QMD App is required,” and upon acknowledging the error message, for example, by the user clicking an “Ok” button, the device 50/method 10, at step 145, is directed to an application store server 65 to download a suitable copy of the application 45.

At step 150, the method/process 10 prompts the user with an option to proceed with installation of the application 45. If the user does not wish to proceed, the method ends. However, if the user elects to proceed with the installation of the application 45, at step 155, the application 45 is installed and registered with the operating system of device 50. Steps 160 and 165 complete the registration/login process with server 60. In this example embodiment, “qmd:/” (an HTTP handler used to launch application 45) is registered and associated with the QMD application 45 that is installed, such that, any device-specific URL containing “qmd:/” automatically (e.g., via a cookie at step 170) opens the QMD application 45 to retrieve (from server 60) and locally display 175 the content associated with the URL.

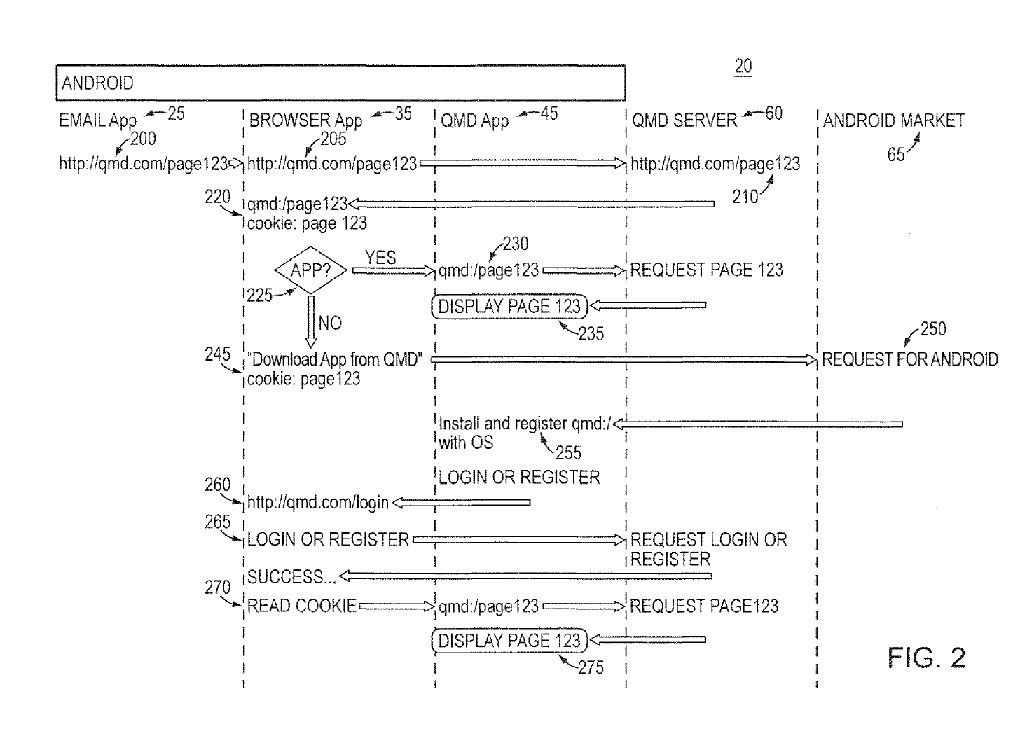

FIG. 2 is a flow diagram of a method or process 20 of hypertext-type link handling implemented on a mobile device 50 using an Android® operating system platform. The method 20 begins at step 200, where a user of an Android® device 50 receives an HTTP link (e.g., ‘http://qmd.com/page123”), which is a device-independent URL, via email using an Android® email application 25 and activates the link. It should be noted that the user may receive the HTTP link via SMS or other alternative communication means known to those skilled in the art. The activation of the HTTP link may occur, for example, by the user clicking the link, highlighting the link, or copy and pasting the link into a web browser 35 installed on the mobile device 50. Upon activation of the link, at step 205, a browser application 35 sends an HTTP request to server 60. The HTTP request may include device 50 profile information such as information related to the operating platform of the device and any other operating information useful to the server 60. In addition, the request may include a cookie that contains the device 50 profile information.

At step 210, the server 60 inspects the request, determines the class of device 50, and responds with a device-dependent URL. The server 60 may determine the class of the device 50 by inspecting the HTTP request. For example, the server 60 may inspect a cookie that contains the device profile information sent with the request, however, if the request does not contain a cookie the server 60 may inspect the request for a browser signature identifying the platform that the device50 is operating on (i.e., class of device). Upon determining the class of the device 50, the server 60, at step 220 responds to the request with a device-dependent URL that is used by the device 50 to retrieve the content of the URL.

At step 225, process/method 20 determines whether the appropriate application 45 needed to retrieve the content from the URL is installed on the device 50. For example, this determination occurs by attempting to access the content of the URL. In the case that the device 50 has the appropriate application 45, at step 230, the application is automatically launched, and the application 45 requests the content from the server 60. Alternatively, in the case where the application 45 is not installed, the device's attempt to launch the appropriate application fails because the application is not installed. In this instance, at step 245, the device 50 is directed to a suitable application store server 65 to download the application 45.

At step 250, the method/process 20 prompts the user with an option to proceed with installation of the application 45. If the user does not wish to proceed, the method 20 ends. However, if the user elects to proceed with the installation of the application 45, at step 255, the application 45 is installed and registered with the operating system of device 50. Steps 260 and 265 complete the registration/login process with server 60. In this example embodiment, “qmd:/” (an HTTP handler used to launch application 45) is registered and associated with the QMD application 45 that is installed, such that, any device-specific URL containing “qmd:/” automatically opens the QMD application 45 to retrieve (from server 60) the content associated with the URL.

After installation and registration of the application 45, step 270 launches the application 45 and in turn the content associated with the device-specific URL is retrieved from server 60. At step 275, the content of the URL is displayed on the device 50 using the installed application 45.

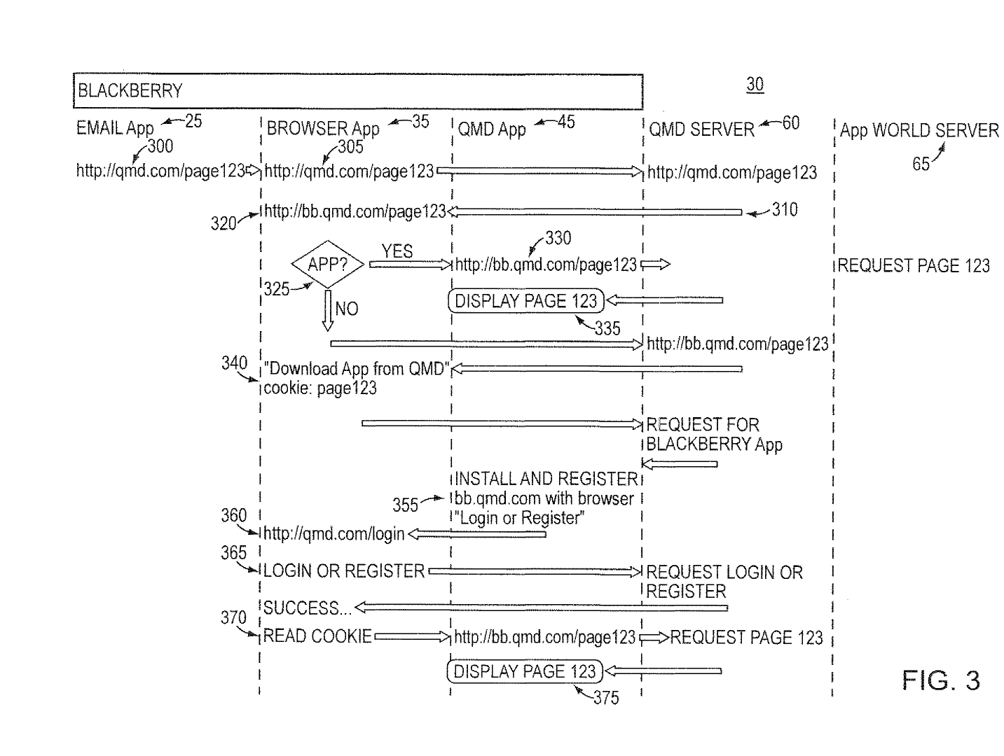

FIG. 3 is a flow diagram of a method/process 30 of hypertext-type link handling implemented on a mobile device 50 using a Blackberry® operating system platform. The method 30 begins at step 300, where a user of an Blackberry® receives an HTTP link (e.g., ‘http://qmd.com/page123”), which is a device-independent URL, via email using an Blackberry® email application 25 and activates the link. It should be noted that the user may receive the HTTP link via SMS or other alternative communication means known to those skilled in the art. The activation of the HTTP link may occur, for example, by the user clicking the link, highlighting the link, or copy and pasting the link into a web browser 35 installed on the mobile device 50. Upon activation of the link, at step 305, a browser application 35 sends an HTTP request to server 60. The HTTP request may include device 50 profile information such as information related to the operating platform of the device 50 and any other operating information useful to the server 60. In addition, the request may include a cookie that contains the device 50 profile information.

At step 310, the server 60 inspects the request, determines the class of device 50, and responds with a device-dependent URL. The server 60 may determine the class of the device 50 by inspecting the HTTP request. For example, the server 60 may inspect a cookie that contains the device profile information sent with the request, however, if the request does not contain a cookie the server 60 may inspect the request for a browser signature identifying the platform the device 50 is operating on (i.e., class of device). Upon determining the class of the device, the server 60, at step 320 responds to the request with a device-dependent URL that is used by the device 50 to retrieve the content of the URL, for example, “http://bb.qmd.com/page123.”

Next, step 325 determines whether the appropriate application 45 needed to retrieve the content from the URL is installed on the device 50. For example, this determination occurs by attempting to access the content of the URL. In the case that the device 50 has the appropriate application, at step 330, the application 45 is automatically launched, and the application 45 requests the content from the server 60. In turn, server 60 serves content pages(s) displayed at 335 through application 45.

Alternatively, in the case where the application 45 is not installed, the device's attempt to launch the appropriate application fails because the domain is not registered with a browser application 35 installed on the Blackberry®. In this instance, step 340 directs the device 50 to an application server 65 to automatically download the application 45.

At step 355, the application 45 is installed and registered with the browser 35 installed on the Blackberry. Steps 360 and 365 complete the registration/login process with server 60. In this example embodiment, handler “bb.qmd.com” is registered and associated with the QMD application 45 that is installed, such that, any device-specific URL containing “bb.qmd.com” automatically opens the QMD application 45 to retrieve the content associated with the URL.

After installation and registration of the application 45, step 370 launches the application 45 and the content associated with the device-specific URL is retrieved from server 60. At step 375, the content of the URL is displayed on the device 50 using the installed application 45.

FIG. 4 illustrates a computer network or similar digital processing environment in which the foregoing and other embodiments of the present invention may be implemented.

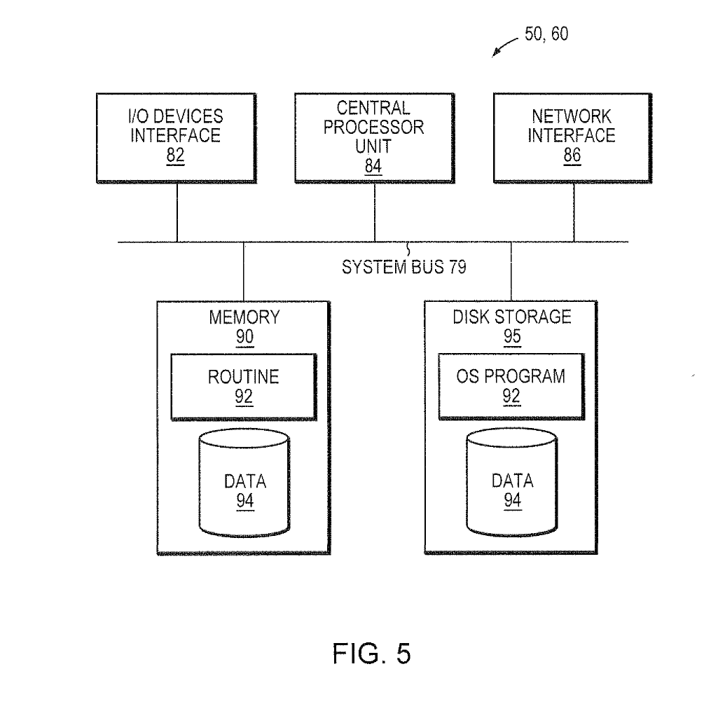

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Servers 60 in FIGS. 4 and 5 may include application store servers 65 and the like. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., code for converting the device 50 independent/generic URL to a device-dependent/specific URL and method/process 10, 20, 30 of invoking a device-specific application through a generic HTTP link as described and detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer program product 92 is carried on a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

In effect, one embodiment of the present invention provides a method of invoking a computer application on a device, comprising:
communicating a hypertext-type link to a client device, the hypertext-type link configured to respond to user activation and make a device-independent URL-request for certain content; and
converting the device-independent URL-request to a device-dependent URL-request specific to the client device. The device-dependent URL-request locally invokes the computer application on the client device to render the certain content. The resulting invoked computer application is client device specific while the initially communicated hypertext-type link is generic (e.g., across devices, platforms, operating systems, etc). Further the hypertext-type link may be embedded in an email message, SMS, web page or similar document.

What is claimed is:

1. A computer implemented method of hypertext-type link handling, comprising:
receiving a request made on a Uniform Resource Locator (URL);
determining a class of device making the request; and
per class of the device, responding with content including redirection instructions to a device-specific URL enabling invocation of a certain application configured to render the content.

2. The computer-implemented method of claim 1 further comprising:
if the certain application is not installed on the device, responding with redirection instructions to a device-specific URL enabling installation of the certain application.

3. The computer-implemented method of claim 1 wherein determining the class of device making the request further includes inspecting the received request for a platform signature and based on the platform signature determining the class of device.

4. The computer-implemented method of claim 1 further comprising determining whether the certain application required to render the content is installed on the device.

5. The computer-implemented method of claim 4 wherein determining whether the certain application is installed on the device further includes inspecting the received request for an encoded registration of the application.

6. The computer-implemented method of claim 4 wherein determining whether the certain application is installed on the device further includes attempting to launch the application on the device and monitoring for a failure of launch of the application.

7. The computer-implemented method of claim 1 further comprising enabling the device to register the certain application to render a particular protocol.

8. The computer-implemented method of claim 1 further comprising enabling the device to register an HTTP handler used to launch the certain application.

9. A computer apparatus for processing and handling hypertext-type links, comprising:
a receiver receiving from a requesting device a request made on a Uniform Resource Locator (URL), the URL referencing content; and
a processor element responsive to the URL request received by the receiver, the processor element determining a class of the requesting device and based on the determined class, providing a device-specific URL enabling the requesting device to invoke a certain application for rendering content referenced by the URL.

10. The computer apparatus as claimed in claim 9 wherein:
if the certain application is not installed on the requesting device, the processor element provides to the requesting device redirection instructions to the device-specific URL enabling installation of the certain application.

11. The computer apparatus as claimed in claim 9 wherein the processor element determining the class of the requesting device includes inspecting the received request for a platform signature and based on the platform signature determining the class of the requesting device.

12. The computer apparatus as claimed in claim 9 wherein the processor element further determines whether the certain application required to render the content is installed on the requesting device.

13. The computer apparatus as claimed in claim 12 wherein the processor element determining whether the certain application is installed on the requesting device further includes inspecting the received request for an encoded registration of the certain application.

14. The computer apparatus as claimed in claim 9 further comprising an application detector that determines whether the certain application is installed on the requesting device by attempting to launch the application on the requesting device and monitoring for a failure of launch of the application.

15. The computer apparatus as claimed in claim 9 further comprising a server enabling the requesting device to register the certain application to render a particular protocol.

16. The computer apparatus as claimed in claim 9 further comprising an HTTP handler registered with the requesting device and associated with the certain application, such that the handler is usable to locally launch the certain application.

17. A method of invoking a computer application on a device, comprising:
communicating a hypertext-type link to a client device, the hypertext-type link configured to respond to user activation and make a device-independent URL-request for certain content; and
converting the device-independent URL-request to a device-dependent URL-request specific to the client device, the device-dependent URL-request enabling local invoking of a computer application on the client device to render the certain content.

18. The method as claimed in claim 17 wherein the device-dependent URL-request further enables determining whether the computer application is installed on the client device.

19. The method as claimed in claim 17 wherein the device-dependent URL-request further enables installing the computer application on the client device.

20. The method as claimed in claim 17 further comprising registering an HTTP handler with the client device to launch the computer application locally.
